(19) United States
(12) Patent Application Publication
(10) Pub. No.: US 2016/0381271 A1
(43) Pub. Date: Dec. 29, 2016

(54) HANDHELD CAMERA STABILIZER WITH INTEGRATION OF SMART DEVICE

(71) Applicant: DelTron Intelligence Technology Limited, Hong Kong (HK)

(72) Inventors: Xuran Cheng, Hong Kong (HK); Cancheng Zeng, Hong Kong (HK)

(21) Appl. No.: 15/193,132

(22) Filed: Jun. 27, 2016

Related U.S. Application Data
(60) Provisional application No. 62/184,265, filed on Jun. 25, 2015.

(51) Int. Cl. H04N 5/232; H04N 5/225

(52) U.S. Cl. CPC H04N 5/2328; H04N 5/2253; H04N 5/23258; H04N 5/23203

(57) ABSTRACT

A handheld stabilizer for automatically stabilizing a camera device, such as a smartphone, when the camera device is mounted on the stabilizer is provided. The stabilizer comprises a camera device mount for holding the camera device, a plurality of motors collectively arranged to cause the camera device mount to be rotatable about three predetermined substantially-orthogonal axes, an inertial-measurement unit (IMU) sensor for measuring an angle and an angular velocity experienced by the camera device about each of the three axes, and a controller. By means of the IMU sensor, an attitude of the camera device is measured. The controller is configured to estimate an attitude error of the camera device according to the measured attitude, and to automatically control the plurality of motors in response to the attitude error so as to controllably rotate the camera device about each of the three axes to counter the attitude error.

### CROSS-REFERENCE TO RELATED APPLICATION

This application claims the benefit of U.S. Provisional Application No. 62/184,265, filed 25 Jun. 2015, the disclosure of which is incorporated by reference herein in its entirety.

### LIST OF ABBREVIATIONS AND TECHNICAL TERMS WITH EXPLANATION

3D Three-dimensional.
ADC Analog-to-digital converter: a device helping a MCU to read a voltage value.
BLDC motor Brushless direct-current motor: a motor that can provide fast response and a torque to stabilize an attitude of a camera device.
DMP Digital motion processor: a processor having a function, provided by the IMU manufacturer, InvenSense, which fuses data from an IMU sensor to get an accurate attitude.
IC Integrated circuit.
IMU Inertial-measurement unit: a sensor that can measure a rotation rate and a direction of gravity, thereby outputting attitude information.
MCU Micro-controller unit: a programmable controller such as STM32 from STMicroelectronics.
MEMS Microelectromechanical system: a working principle for one type of IMU.
NFC Near field communication.
Rheostat A variable resistor that can output different voltages with different fractions of resistance used.
PID Proportion, integration and differentiation.
PLA Polylactic acid or polylactide: a kind of plastic that can be used for 3D printing.

### BACKGROUND

Field of the Invention

The present invention generally relates to a handheld stabilizer for a camera device such as a smartphone. In particular, the present invention relates to such handheld stabilizer that stabilizes an attitude of the camera device for maintaining good photo/video shooting quality by one or more electrical motors, such as a BLDC motor, a servo motor or a stepper motor, with help from an IMU sensor.

Description of the related Art

It is often desirable to use a stabilization technique or mechanism to stabilize a handheld camera system for combating against possible motional disturbance to the camera system such that the photo- or video-taking quality is maintained or is only marginally degraded. U.S. Pat. No. 7,642,741 has disclosed one stabilization system that uses two rotary mechanisms to stabilize the pitch attitude and the yaw attitude of a camera device. However, there are three rotary axes in the camera device, so that the roll attitude cannot be stabilized by the stabilization system disclosed in U.S. Pat. No. 7,642,741. In addition, no integration is built between the stabilizer and the camera device. Hence, a user needs to control the camera device and the stabilizer separately. This arrangement is not user-friendly. Another stabilization system, disclosed in U.S. Patent Application No. 2015/0071627, uses a bidirectional DC motor with a gear train as an actuator to stabilize a camera. This stabilization mechanism has a large torque but results in a long response time. Hence, the resultant stabilization effect may be not good. In addition, the configuration of this stabilization mechanism can only provide attitude stabilization about two axes: the roll attitude and the pitch attitude.

It is observed that, insofar as the Inventors are aware of, there is a lacking of a stabilizer that can provide fast response stabilization for a camera device for three rotary axes (pitch, roll and yaw) as well as that is integrated with the camera device. There is a need in the art for such stabilizer.

### SUMMARY OF THE INVENTION

An aspect of the present invention is to provide a handheld stabilizer for automatically stabilizing a camera device when the camera device is mounted on the stabilizer. The stabilizer comprises a camera device mount, a plurality of motors, an IMU sensor, and a controller. The camera device mount is used for holding the camera device.

The motors are collectively arranged to cause the camera device mount to be rotatable about three pre-determined substantially-orthogonal axes. Preferably, the three axes are a pitch axis, a roll axis and a yaw axis. Usually, the number of the motors is three. The IMU sensor is used for measuring an angle and an angular velocity experienced by the camera device about each of the three axes, whereby an attitude of the camera device is measured. Preferably, the IMU sensor is joined to the camera device mount such that the IMU sensor is physically adhered to the camera device. The controller is configured to estimate an attitude error of the camera device according to the measured attitude. Preferably, the attitude error is estimated by comparing the measured attitude with a target attitude. The controller is further configured to automatically control the plurality of motors in response to the attitude error so as to controllably rotate the camera device about each of the three axes to counter the attitude error. Thereby, the camera device is stabilized about all of the three axes.

It is preferable that the controller is communicable with the camera device, and is configured to accept instructions from the camera device such that the stabilizer enables the camera device to rotate as intended by the camera device while the attitude error experienced by the camera device is counteracted. The controller may be wirelessly communicable with the camera device via Bluetooth.

The controller may be further configured to wirelessly receive the target attitude from the camera device by using Bluetooth technology, WiFi or NFC. The stabilizer may further comprise an on-board control interface for receiving the target attitude manually from a user. The on-board control interface may be a joystick or a revolving rheostat.

Optionally, at least one of the motors is a BLDC motor, a stepper motor or a servo motor.

Other aspects of the present invention are disclosed as illustrated by the embodiments hereinafter.

### BRIEF DESCRIPTION OF THE DRAWINGS

FIG. 1 depicts a perspective view of a first embodiment of a disclosed handheld stabilizer, where the stabilizer holds an iPhone 6 for illustrating an operation situation of the stabilizer.

FIG. 2 is a perspective view of the first embodiment of the stabilizer viewed from below, showing a battery container 24.

FIG. 3 is a perspective view of the first embodiment of the stabilizer.

FIG. 4 is an exploded view of the first embodiment of the stabilizer.

FIG. 5 is another exploded view of the first embodiment of the stabilizer with a viewing angle different from that of FIG. 4.

FIG. 6 is yet another exploded view of the first embodiment of the stabilizer viewed from below.

FIG. 7 is a flowchart exemplarily illustrating how an overall mechanical and electrical system of the first embodiment of the stabilizer works.

FIG. 8 is a flowchart specifically illustrating how a controller of the first embodiment of the stabilizer works.

FIG. 9 illustrates the definitions of pitch, roll and yaw as used in describing a frame of a camera device.

FIG. 10 is an illustration of a stabilizer performing a tracking function.

FIG. 11 is an illustration of a stabilizer automatically or manually taking a panorama photo.

FIG. 12 is an illustration of a seamless switch of shooting mode for a stabilizer (between a portrait mode and a landscape mode).

FIG. 13 is a perspective view of the second embodiment of the stabilizer where the stabilizer operates in a landscape shooting mode.

FIG. 14 is a perspective view of the second embodiment of the stabilizer where the stabilizer operates in a portrait shooting mode.

FIG. 15 is a perspective view of a third embodiment of the stabilized viewed from below.

FIG. 16 is a perspective view of the third embodiment of the stabilizer viewed from above.

FIG. 17 is another perspective view of the third embodiment of the stabilizer where the stabilizer is in an operating state, i.e. when a user is holding a handle 20″ in a way that the handle 20″ is pointing forward.

FIG. 18 provides a detailed view of a joystick and a revolving rheostat assembled on one version of the stabilizer.

### DETAILED DESCRIPTION

As used herein in the specification and the appended claims, “a camera device” means a portable electronic device having computing power and a functionality of taking photos or videos. For example, a camera device may be a smartphone such as an iPhone 6 and an iPhone 4S.

Although the invention is hereinafter described in embodiments predominantly based on example applications of the invention to iPhone 6 and iPhone 4S, the present invention is not limited only for applications to these types of iPhone. The present invention is applicable to any camera device having a camera for photo taking.

An aspect of the present invention is to provide a handheld stabilizer for automatically stabilizing a camera device when the camera device is mounted on the stabilizer. The stabilizer has a mechanism for mounting or securing the camera device on the stabilizer. It is understood that the camera device is detachable from the stabilizer, and can be removed therefrom if desired. One advantage of the stabilizer disclosed herein is that it provides fast response such that stabilization of the camera device about three rotary axes is realizable even under fierce vibration circumstance. Another advantage follows from integrating a control interface on the stabilizer's gimbal with the camera device, making the stabilizer more user-friendly.

### A. First Embodiment of the Stabilizer

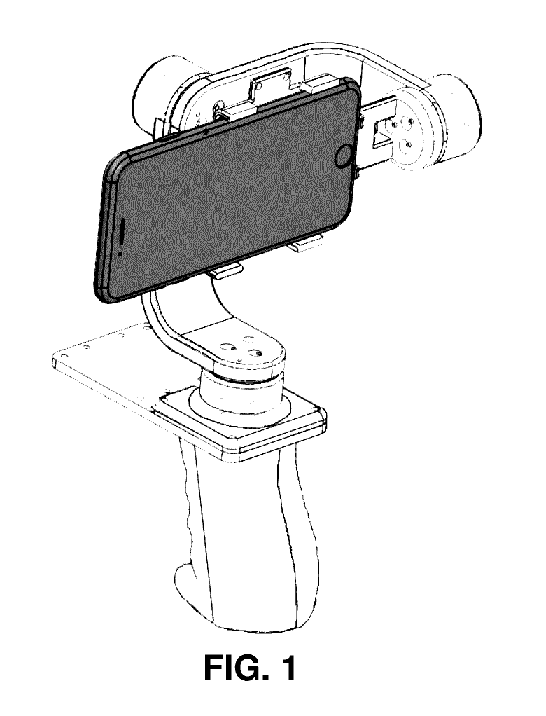

FIG. 1 depicts a perspective view of a first embodiment of the disclosed handheld stabilizer holding an iPhone 6 as an illustration of the operation of the first embodiment.

### A.1. Structure

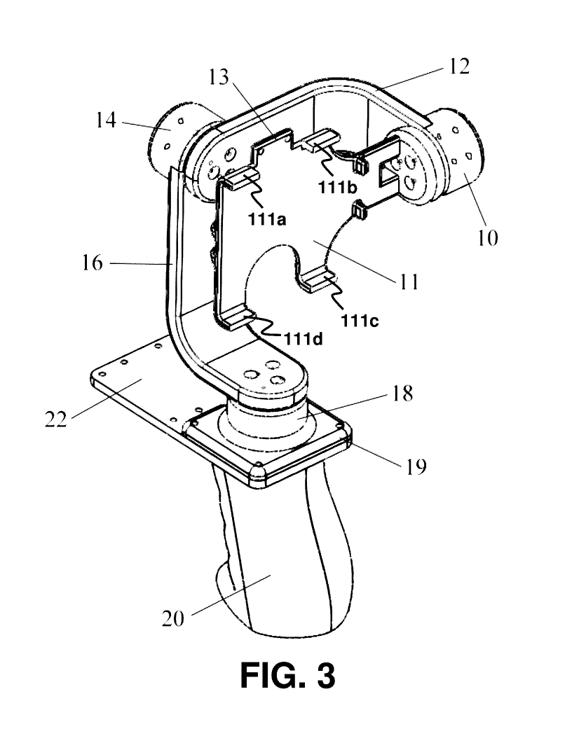

FIG. 3 is a perspective view of the first embodiment of the stabilizer. A camera device mount 11 is a mechanism for holding the camera device (e.g. a sport camera like Gopro and a smartphone with photo- and video-taking functionality such as an iPhone). Typically, the holding mechanism can be implemented with 4 fixed holders 111a-d to hold the camera device. However, the holding mechanism can also have a different mechanism to hold the camera device, such as a width-adjustable mounting mechanism and any mechanism of different shape, different size and materials. The stabilizer includes an IMU sensor 13. In one option, the IMU sensor 13 is joined to the camera device mount 11. Thus, the IMU sensor 13 can faithfully measure the attitude of the camera device. Alternatively, the IMU sensor 13 may be in any part of the stabilizer other than the camera device mount 11, provided that the measurement results made by the IMU sensor 13 truly reflects undesired rotation experienced by the camera device. The measurement data measured by the IMU sensor 13 are sent to a controller by cable. Some space is reserved between the camera device and a motor A 10 (to be explained), enabling the cable to be inserted while the stabilizer is operating for some application such as transferring data or charging the camera device, etc.

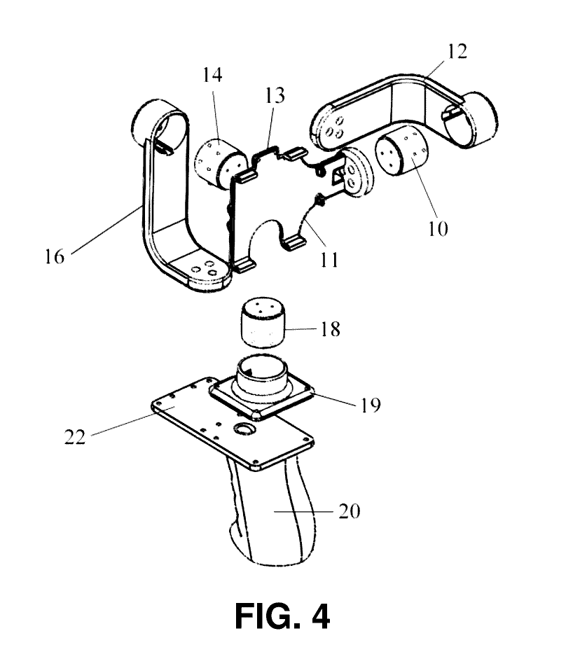

FIG. 4 is a perspective view of the first embodiment of the stabilizer. The camera device mount 11 is joined to the motor A 10. Preferably, a BLDC motor is used for realizing the motor A 10 due to the generally fast response provided by the BLDC motor. However, the motor A 10 can also be realized by a stepper motor or a servo motor, etc. The motor A 10 is joined to a connection bar A 12, where the connection bar A 12 is substantially-rigid. One may use 3D printing to construct the connection bar A 12 from PLA. However, other material is also suitable, for example, plastic such as ABS, and metal such as aluminum alloy and carbon steel. The connection bar A 12 is joined to a motor B 14. It is possible to use a BLDC motor for the motor B 14. However, the motor B 14 can also be realized as a stepper motor or a servo motor. The motor B 14 is joined to a connection bar B 16. Similarly, the connection bar 16 is substantially-rigid. It is preferable to use 3D printing to construct the connection bar B 16 from PLA. Nonetheless, other material is also suitable, for example, plastic such as ABS, and metal such as aluminum alloy and carbon steel.

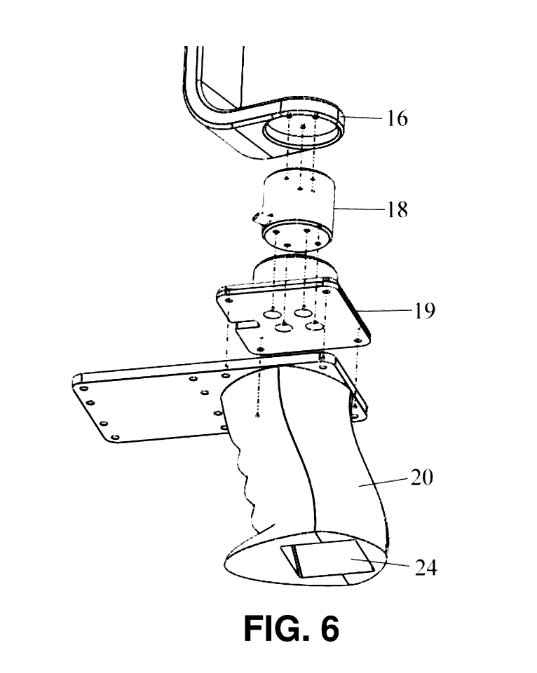

FIG. 6 is an exploded view of the first embodiment of the stabilizer, showing how the connection bar B 16, a motor C 18, a motor mount base 19 and a handle 20 are integrated together. The connection bar B 16 is joined to the motor C 18. It is possible to use a BLDC motor for the motor C 18. However, the motor C 18 can also be a stepper motor or a servo motor, etc.

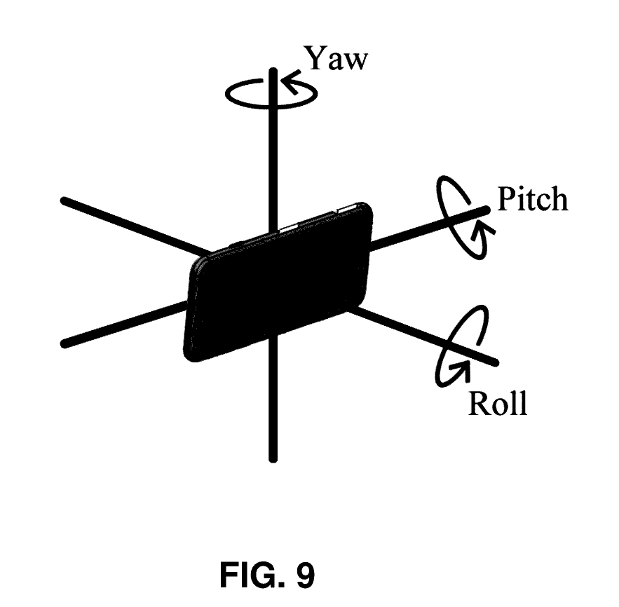

In the stabilizer, the motor A 10, the motor B 14 and the motor C 18 are collectively arranged to cause the camera device mount 11 to be rotatable about three predetermined substantially-orthogonal axes. As the camera device mount 11 is used to hold the camera device, preferably and conveniently, these three substantially-orthogonal axes are selected to be a pitch axis, a roll axis and a yaw axis all of which are used in describing a frame of the camera device. For reference, FIG. 9 depicts the arrangement for the pitch axis, the roll axis and the yaw axis for the camera device. Since the rotation axis of each of the motor A 10, the motor B 14 and the motor C 18 is easily identified from each motor's rotation shaft, and since the three motors 10, 14, 18 and the camera device mount 11 are substantially-rigidly connected together through the connection bar A 12 and the connection bar B 16, those skilled in the art are easy to understand that the rotation axes of the three motors 10, 14, 18 are mutually substantially-orthogonal.

Refer to FIG. 6 again. The motor C 18 is joined to the motor mount base 19, and the motor mount base 19 is joined to the handle 20. The motor mount base 19 and the handle 20 may be made of PLA. It is preferable that the handle 20 has an ergonomically designed shape that fits a user's hand and makes the user feel comfortable to hold. However, the handle 20 can also have different shapes, such as the shapes having cross-sections that are circular, triangular, oval, etc. The handle 20 may also be made of different material such as plastic like ABS, and metal like aluminum alloy and carbon steel.

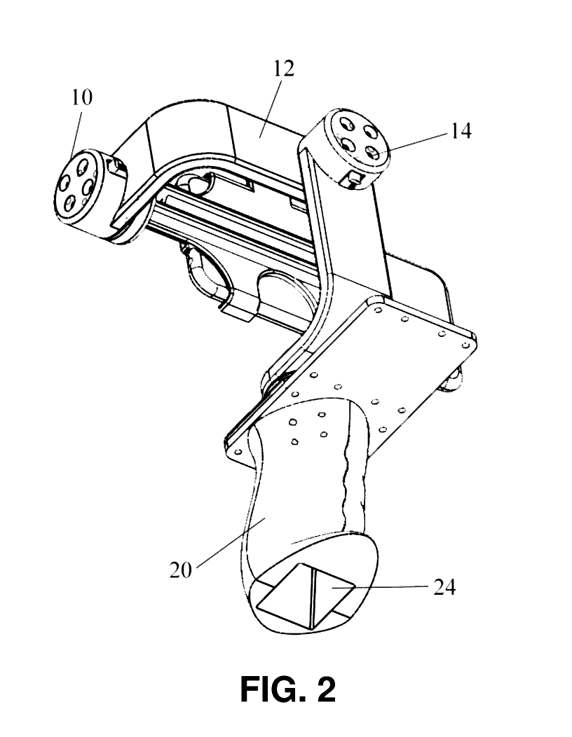

FIG. 2 is a perspective view of the first embodiment of the stabilizer viewed from below, showing a battery container 24. In one option, the battery container 24 has a 3 cm×3 cm square cross-section and a 5 cm length. However, the battery container 24 may also have different cross-sectional shapes, such as an oval shape, a triangular shape, a circular shape, etc., and may have different sizes and materials, such as ABS, aluminum alloy, etc.

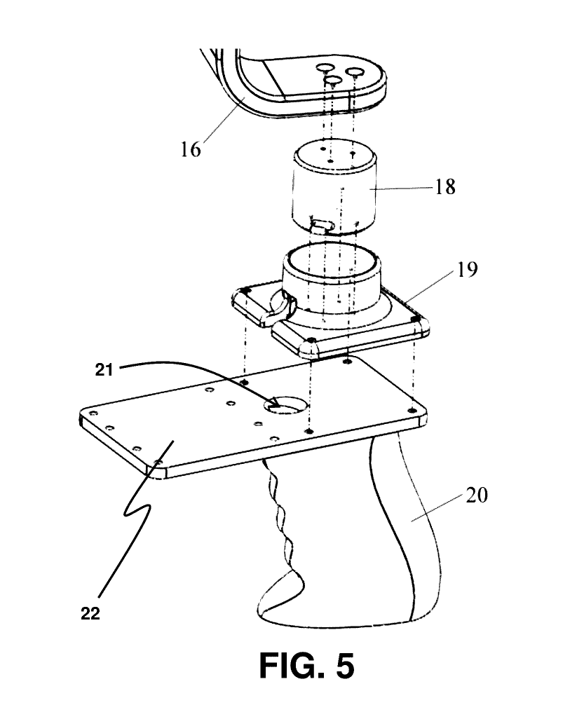

FIG. 5 provides an exploded view of the first embodiment of the stabilizer with a viewing angle different from that of FIG. 4. A power cable hole 21 is a hole that allows a power cable to go through, from a battery in the battery container 24 to a circuit board placed on a space for circuit board 22.

### A.2. Operation

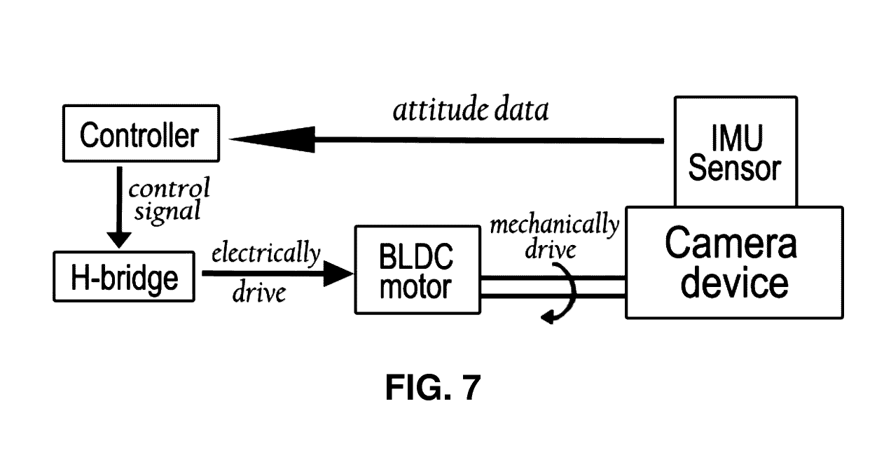

FIG. 7 is a flowchart exemplarily showing how an overall control system is designed to stabilize the camera device. The IMU sensor 13 is used for measuring an angle and an angular velocity experienced by the camera device about each of the three predetermined substantially-orthogonal axes, whereby an attitude of the camera device is measured. By joining the IMU sensor 13 to the camera device mount 11, the IMU sensor 13 is physically adhered to the camera device. Thus, the IMU sensor 13 can accurately measure attitude (pitch, roll and yaw) data without any delay. One may use a MEMS IMU, MPU 9250 from InvenSense, to realize the IMU sensor 13. However, other attitude sensors based on same or different principles are also suitable. The attitude data are then sent to a controller, and the controller generates driving signals based on the input data from the IMU sensor 13 to an H-bridge IC, and the H-bridge IC electrically drives one or more BLDC motors (realizing one or more of the motor A 10, the motor B 14 and the motor C 18) to rotate in order to counter undesired rotation of the camera device. Optionally, one can use STM32 from STMicroelectronics as the controller, DRV8318 from Texas Instruments as the H-bridge IC, and GB2208 gimbal motor from T-Motor as a three-phase BLDC motor (for implementing the motor A 10, the motor B 14 and the motor C 18).

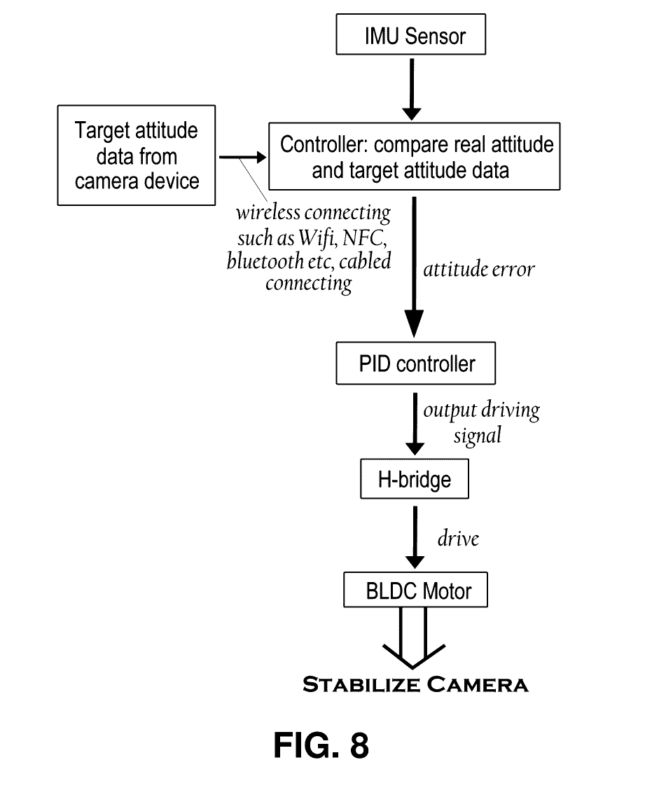

FIG. 8 is a flowchart serving as an example for specifically showing how the controller works. The target attitude data are sent from the camera device to the controller by Bluetooth 4.0 technology. Then the controller compares the target attitude and the measured attitude to get attitude error information. It is possible to use iPhone 6 as the camera device. However, the camera device can also be another smartphone equipped with a camera, or another camera of different size and of a different manufacturer such as Gopro Hero3 and Hero 4, etc. Optionally, one may use Bluetooth 4.0 technology for communication between the camera device and the stabilizer controller. However, one may also use other wireless connection, such as Wifi, NFC, etc., and cabled connection.

FIG. 9 illustrates the definitions of pitch, roll and yaw for use in describing a frame of a camera device in the following discussion.

The IMU sensor 13 is adhered to the camera device so that the IMU sensor 13 can accurately measure a definite angle and an angular velocity about the pitch, roll and yaw axes by applying the DMP (e.g., Digital Motion Processor from the manufacturer InvenSense) function, which helps to a fuse accelerometer, a gyroscope and a magnetic concentrator, and gets the attitude data (i.e. the measured attitude). According to FIG. 8, all attitude data are sent to the controller, and the controller compares the measured attitude with a target attitude and adjusts the attitude of the camera device by driving appropriate BLDC motors. The target attitude is usually received by the controller from the camera device. To enable the controller to receive the target attitude, it is required that the controller is communicable with the camera device, e.g., by Bluetooth, WiFi, NFC, or by a cabled connected.

We may refer to a stabilization process of pitch axis as an example. Once the camera device undesirably tilts forward or backward, the angular velocity will be detected by the IMU sensor 13 and the controller compares the target attitude and the measured attitude, and gets an attitude error. The attitude error data is processed by a PID controller, and the PID controller generates a driving signal to the H-bridge IC to electrically drive a BLDC motor (the motor A 10) to controllably rotate backward or forward to eliminate the attitude error. Thus, the stabilizer counteracts the attitude error. It follows that the camera device is automatically stabilized around the pitch axis, and the photo/video shooting quality is enhanced. The stabilization process around the roll and yaw axes is similar, but the controller compares roll- and yaw-attitude data and mechanically eliminates the attitude error by the motor B 14 and the motor C 18.

According to FIG. 8, it is possible that the controller takes the target attitude from the camera device like iPhone 6. However, the target attitude can be manually set by a user through an on-board control interface such as a joystick and a potentiometer. For example, the user can set pushing the joystick upward as increasing the pitch target attitude.

Some software applications executable on the camera device can be created to enable communication between the camera device and the stabilizer. The controller of the stabilizer may be further configured to accept instructions from the camera device such that the stabilizer, by controllably rotating the camera device mount 11 through actions of the three motors 10, 14, 18, enables the camera device to rotate as intended by the camera device while the undesired attitude error experienced by the camera device is counteracted.

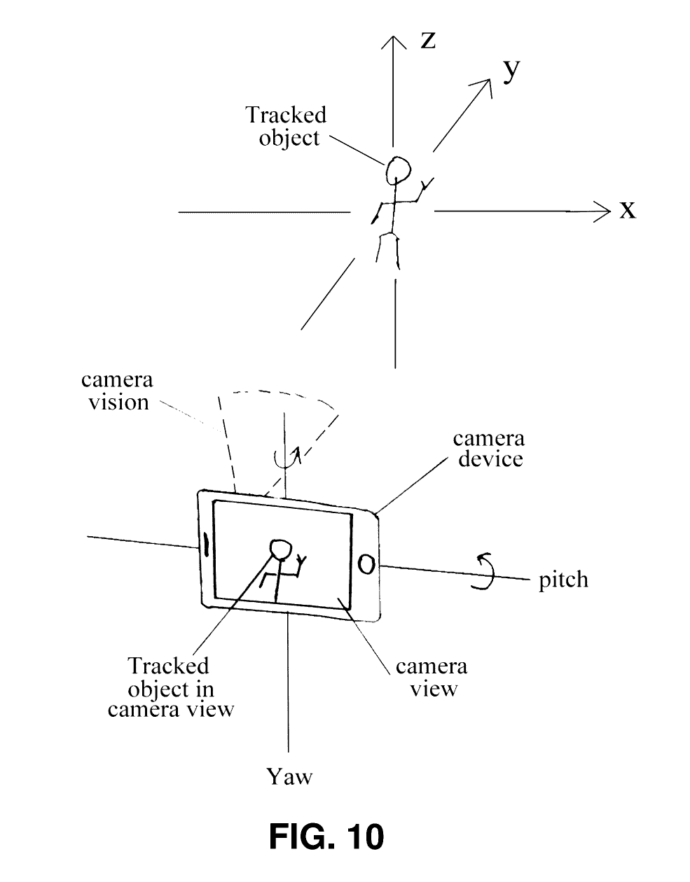

FIG. 10 provides an illustration of an auto-tracking function. An app running on the camera device, such as iPhone 6, can detect an object (e.g., a human face in this example) that one wants to track in the captured view of the camera device. Once the object is moving to the boarder of a camera view and is about to move out of the camera view, the app can determine a rotation direction, in which the camera device can follow the tracked object and prevents the object from going out of the camera view. Furthermore, based on the rotation direction, the app can determine new target attitude yaw, pitch and roll attitudes, and send new target attitude data to the stabilizer. Hence, the stabilizer can smartly track the object that the user decides in the app. An example of application can be auto-tracking of the user while shooting videos/photos or making a video call. The user can allow the app to be a cameraman and let users create more methods to shoot photos/videos by using the stabilizer based on the tracking feature of whole stabilizer system.

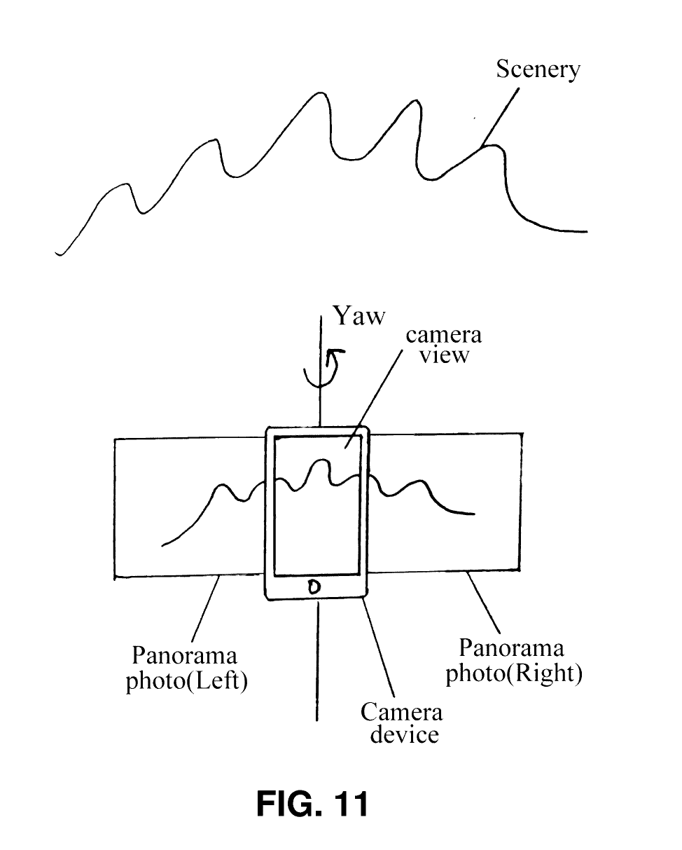

FIG. 11 illustrates how the stabilizer can help to shoot a panorama photo. A panorama photo as shown in FIG. 11 shows the whole panorama photo captured by the camera device. If the panorama photo is taken by the camera device solely controlled by hands without a stabilizer, the output panorama photo tends to be distorted because of an inconstant roll attitude of the camera device. The disclosed stabilizer can stabilize the roll attitude of the camera device while the panorama photo is taken. Hence, an enhanced panorama photo can be taken. The stabilizer can drive the camera device automatically to pan around the yaw axis to take the panorama photo. It can be done by setting the target yaw attitude continuously by the app on the camera device or by an on-board control interface like a joystick. One can write a script in the app running in the camera device and let the camera device rotate around the yaw for a range of target yaw attitude set by the script. By panning around the yaw axis, the stabilizer can work with the camera device to automatically capture the panorama photo while counteracting the attitude error to stabilize the camera device. With the roll attitude fixed and the pitch attitude fixed or varying through a capture process, the stabilizer can help to take a sphere panorama.

### B. Second Embodiment of the Stabilizer

### B.1. Structure

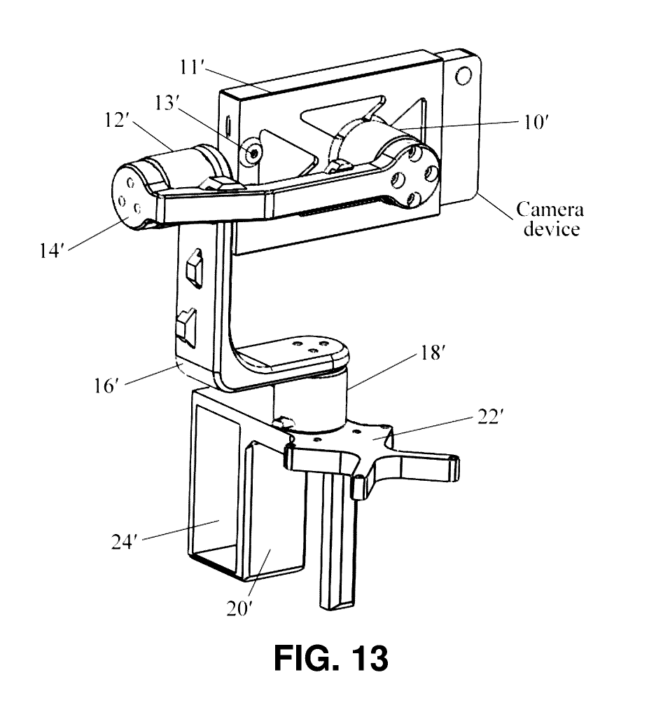

FIG. 13 is a perspective view of a second embodiment of the disclosed stabilizer. The whole second embodiment of the stabilizer comprises similar components of the stabilizer set forth in the first embodiment. A camera device mount 11′ holds an iPhone 4S as the camera device and is joined to a motor A 10′. It is possible to attach an IMU sensor 13′ to the camera device mount 11′ by screws. However, other methods of attaching the IMU sensor 13′ are also suitable, for example, using glue. A connection bar A 14′ is joined to the motor A 10′ and a motor B 12′. A connection bar B 16′ is joined to the motor B 12′ and a motor C 18′. The motor C 18′ is joined to a handle 20′. A space for a circuit board 22′ is a space for housing a controller circuit board. A battery container 24′ is a storage space for one or more batteries.

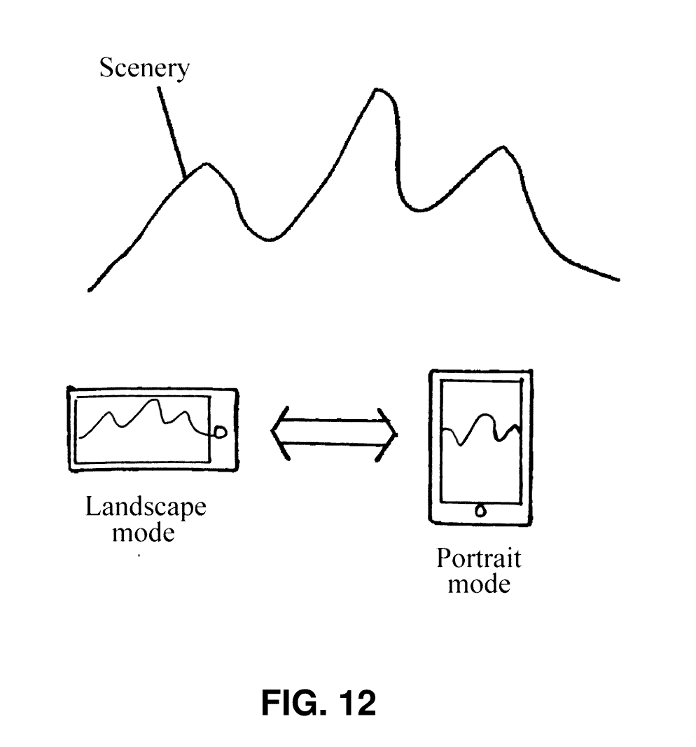

FIG. 12 illustrates the definition of two shooting modes (portrait shooting mode and landscape shooting mode) to be discussed later.

### B.2. Operation

The stabilization principle is the same as the one introduced for the first embodiment.

FIG. 9 provides reference-frame definition of a camera device to be used in the discussion of the following context.

A motor A 10′ of the second embodiment of the stabilizer mechanically stabilizes a roll attitude of the camera device. A motor B 12′ stabilizes a pitch attitude. A motor C 18′ stabilizes a yaw attitude.

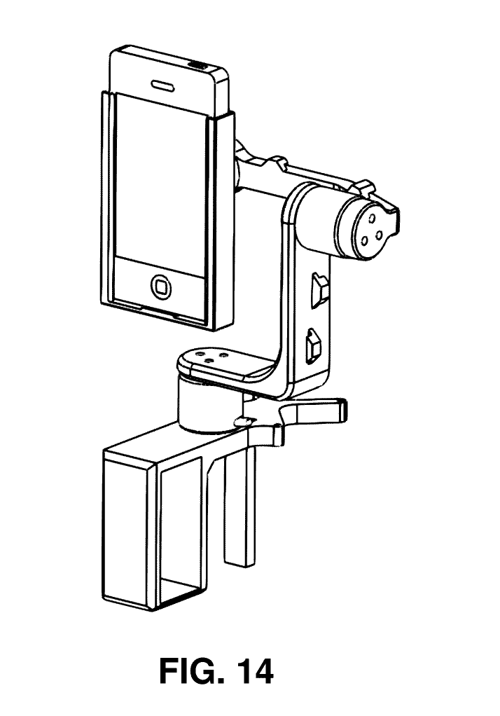

FIG. 14 is perspective view of the second embodiment of the stabilizer where the camera device is positioned in a portrait shooting mode while the camera device shown in FIG. 13 is in a landscape shooting mode. (FIG. 12 provides an illustration of shooting mode of the camera device.) The stabilizer can provide a seamless mode-switch function that enhances user experience. Once a user uses his or her hand to force the camera device to change the roll attitude by about 90 degrees such that the roll attitude of the camera device is about the same as the roll attitude of the portrait mode, the IMU sensor 13′ will detect this manner from the user and start to stabilize the camera device about a portrait-mode attitude and vice versa. Thus, the user can switch between the portrait mode and the landscape mode seamlessly and simply by rotating the camera device by hand for about 90 degrees, and user experience is enhanced.

### C. Third Embodiment of the Stabilizer

### C.1. Structure

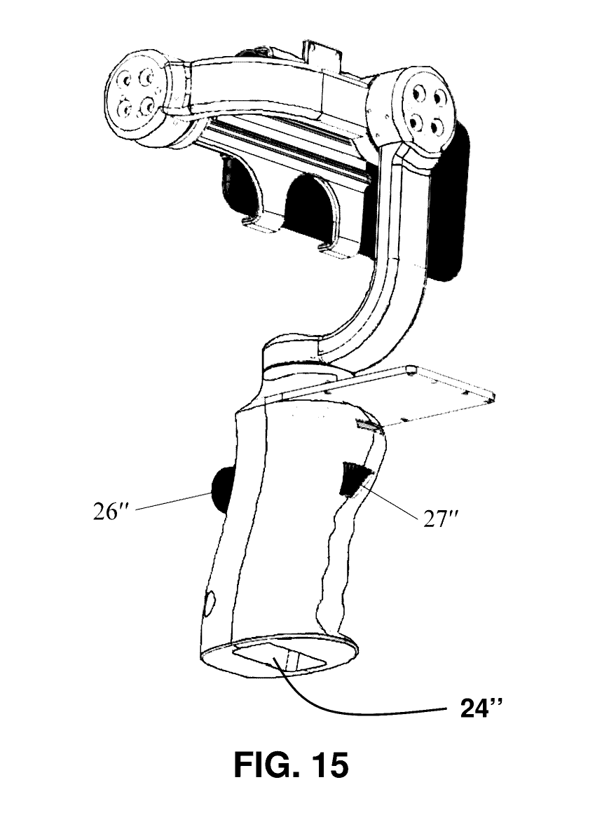

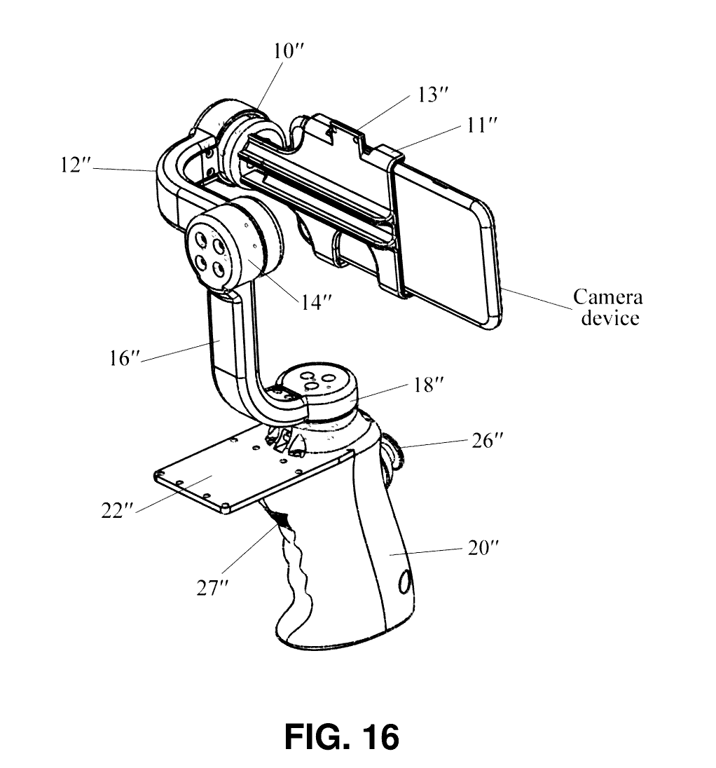

FIG. 16 is a perspective view of a third embodiment of the stabilizer viewed from above. The whole third embodiment comprises similar components of the stabilizer set forth in the first embodiment. A camera device mount 11″ holds an iPhone 6 as the camera device and is joined to a motor A 10′. It is possible to attach an IMU sensor 13″ to the camera device mount 11″ by screws. However, other methods of attachment are also suitable, for example, using glue. A connection bar A 14″ is joined to the motor A 10″ and the motor B 12″. A connection bar B 16″ is joined to the motor B 12″ and the motor C 18″. The motor C 18″ is joined to a handle 20″. A space for circuit board 22″ is a space to allocate a controller circuit board. The controller circuit board attached on the handle 20″ has an additional IMU sensor so that the controller can measure the attitude of the handle 20″. A battery container 24″ (See FIG. 15) is a storage space for one or more batteries.

FIG. 15 is a perspective view of the third embodiment of the stabilizer viewed from below, showing that a joystick 26″ and a revolving rheostat 27″ are assembled in handle 20″. The joystick 26″ includes two revolving rheostats perpendicularly aligned with each other and a press key so that the joystick 26″ can help the controller determine in which way the user is pushing the joystick 26″ and whether the user is pressing the joystick 26″. The revolving rheostat 27″ can help the controller to determine whether the user is pushing the revolving part leftward or rightward.

### C.2. Operation

The stabilization principle is the same as that introduced for the first embodiment.

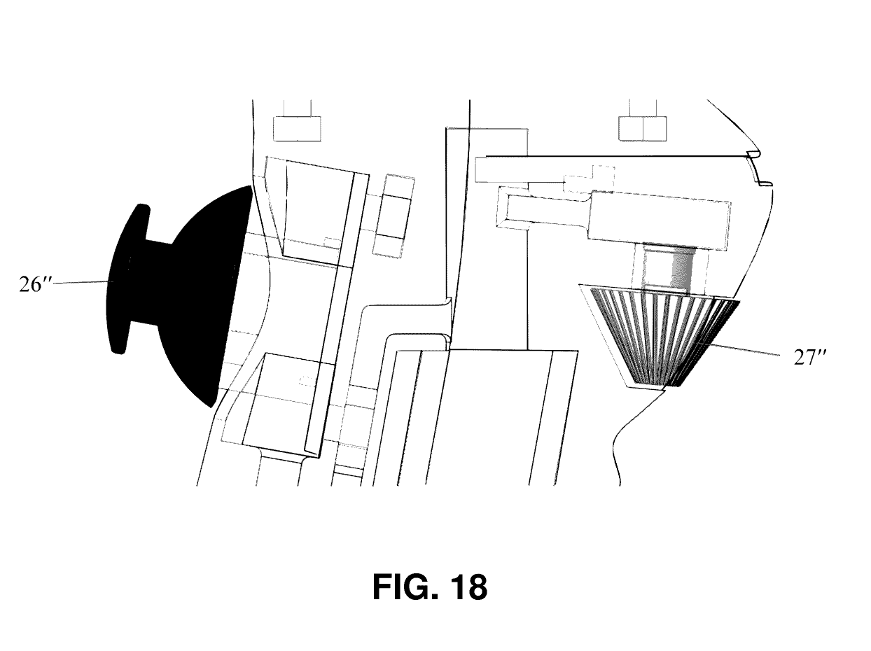

FIG. 18 provides a detailed view of the joystick 26″ and the revolving rheostat 27″, both of which help the user to control the target attitude of the camera device when a photo/video/panorama shooting app is running in the camera device like iPhone. One can connect a VCC pin and a GND pin of the rheostat 27″ to a 3.3V power source and an output pin thereof to an analog-to-digital converter pin of the controller. Hence, the controller can read a voltage output of the rheostat 27″ and determine a state of rheostat (i.e. a revolved angle) and a direction of pushing by the user. These interactive sensors (namely, the joystick 26″ and the rheostat 27″) assembled on the stabilizer can derive some user-friendly applications. For example, once the user presses down the joystick 26″, the controller of the stabilizer sends this signal to the camera device via Bluetooth wireless connection and the camera device recognizes this signal as an order to start shooting photo/video, or order the camera to capture a photo while the attitude of camera device is totally fixed in order to avoid obtaining a blurred photo. Another example is that the user can control zooming of the camera simply by pushing the revolving rheostat 27″. Once the user pushes the revolving rheostat 27″, the state signal is sent to the camera device via Bluetooth and the camera device adjusts zooming of the camera based on the state information sent from the stabilizer. It is contemplated that the interactive sensor is a joystick and the connection between the stabilizer and the camera is based on Bluetooth 4.0 technology. However, other interactive sensors of same or different principle, material, size, etc. are also suitable such as a linear rheostat and an infrared touch sensor. Other number of sensors and arrangement is also suitable. Through the interactive sensors assembled in the stabilizer, the user can easily interact with the stabilizer and the camera device so that the user can easily control the camera state and the stabilizer state.

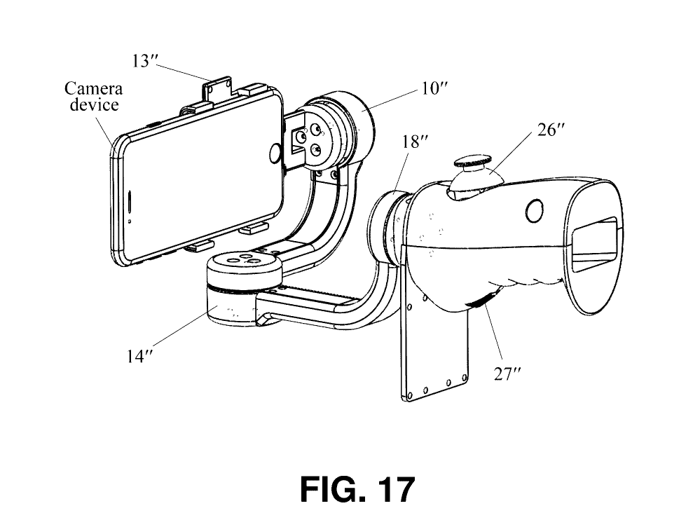

FIG. 17 is a perspective view of the third embodiment of the stabilizer in an operating state with the handle 20″ pointing forward. The operation attitude of a handle of a stabilizer disclosed in the prior art is only within a range of +/−45 degrees in pitch or roll, because the gimbal system disclosed in the prior art does not recognize an attitude of the handle, and the motor B 14″ and the motor C 18″ are constantly stabilizing the roll attitude and the yaw attitude of the camera device. It is preferable that the third embodiment of the stabilizer has an IMU sensor on a circuit board assembled on a space for circuit board 22″ so that the controller can determine the attitude of the handle 20″ and automatically assign duty to each motor. For example, in the normal operation state shown in FIG. 16, the motor A 10″, the motor B 14″ and the motor C 18″ are in charge of stabilizing the pitch, roll and yaw attitudes of the camera device, respectively. Whereas for the operation shown in FIG. 17, the motor B 14″ and the motor C 18″ are in charge of stabilizing the yaw and roll attitudes of the camera device, respectively. Once the handle 20″ exceeds an attitude limit of the normal state of +/−45 pitch or roll attitude, the controller can reassign duty to each motor based on the attitude information of the handle 20″. Thus, the operation angle of the stabilizer is no longer limited to +/−45 degrees, so that user experience is further enhanced.

### D. Remarks

The controller of the stabilizer disclosed herein may be implemented by including general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A handheld stabilizer for automatically stabilizing a camera device when the camera device is mounted on the stabilizer, comprising:
a camera device mount for holding the camera device;
a plurality of motors collectively arranged to cause the camera device mount to be rotatable about three pre-determined substantially-orthogonal axes;
an inertial-measurement unit (IMU) sensor for measuring an angle and an angular velocity experienced by the camera device about each of the three axes, whereby an attitude of the camera device is measured; and
a controller configured to estimate an attitude error of the camera device according to the measured attitude, and to automatically control the plurality of motors in response to the attitude error so as to controllably rotate the camera device about each of the three axes to counter the attitude error, thereby stabilizing the camera device about all of the three axes.

2. The stabilizer of claim 1, wherein the three axes are a pitch axis, a roll axis and a yaw axis.

3. The stabilizer of claim 1, wherein the controller is communicable with the camera device, and is further configured to accept instructions from the camera device such that the stabilizer enables the camera device to rotate as intended by the camera device while the attitude error experienced by the camera device is counteracted.

4. The stabilizer of claim 3, wherein the controller is wirelessly communicable with the camera device via Bluetooth.

5. The stabilizer of claim 1, wherein the attitude error is estimated by comparing the measured attitude with a target attitude.

6. The stabilizer of claim 5, wherein the controller is further configured to wirelessly receive the target attitude from the camera device by using Bluetooth technology.

7. The stabilizer of claim 5, wherein the controller is further configured to wirelessly receive the target attitude from the camera device by using WiFi or NFC.

8. The stabilizer of claim 5, wherein the controller is further configured to receive the target attitude from the camera device via a cabled connection.

9. The stabilizer of claim 5, further comprising:
an on-board control interface for receiving the target attitude manually from a user.

10. The stabilizer of claim 9, wherein the on-board control interface is a joystick or a revolving rheostat.

11. The stabilizer of claim 1, wherein the number of the motors is three.

12. The stabilizer of claim 1, wherein at least one of the motors is a brushless direct-current (BLDC) motor.

13. The stabilizer of claim 12, further comprising:
an H-bridge integrated circuit (IC) for electrically driving the BLDC motor according to a driving signal generated by the controller.

14. The stabilizer of claim 1, wherein at least one of the motors is a stepper motor or a servo motor.

15. The stabilizer of claim 1, wherein the IMU sensor is joined to the camera device mount such that the IMU sensor is physically adhered to the camera device.

16. A handheld stabilizer for automatically stabilizing a camera device when the camera device is mounted on the stabilizer, comprising:
a camera device mount for holding the camera device;
an inertial-measurement unit (IMU) sensor, joined to the camera device mount such that the IMU sensor is physically adhered to the camera device, for measuring an angle and an angular velocity experienced by the camera device about each of three substantially-orthogonal axes, the three axes being a pitch axis, a roll axis and a yaw axis, whereby an attitude of the camera device is measured;
a first motor, joined to the camera device mount, for rotating the camera device mount;
a first connection bar joined to the first motor;
a second motor, joined to the first connection bar, for rotating the first connection bar;
a second connection bar joined to the second motor;
a third motor, joined to the second connection bar, for rotating the second connection bar, wherein the first, second and third motors are collectively arranged to cause the camera device mount to be rotatable about the three axes, and;
a motor mount base, joined to the third motor, for supporting the third motor;
a handle, joined to the motor mount base, for enabling a user to hold the stabilizer; and
a controller configured to:
estimate an attitude error of the camera device by comparing the measured attitude with a target attitude; and
automatically control the plurality of motors in response to the attitude error so as to controllably rotate the camera device about each of the three axes to counter the attitude error, thereby stabilizing the camera device about all of the three axes;
be communicable with the camera device; and
accept instructions from the camera device such that the stabilizer enables the camera device to rotate as intended by the camera device while the attitude error experienced by the camera device is counteracted.

17. The stabilizer of claim 16, further comprising:
a battery container, located in the handle, for housing one or more batteries that provide electrical power to the stabilizer.

18. The stabilizer of claim 16, wherein the controller is further configured to wirelessly receive the target attitude from the camera device by using Bluetooth technology.

19. The stabilizer of claim 16, further comprising:
an on-board control interface for receiving the target attitude manually from the user.

20. The stabilizer of claim 19, wherein the on-board control interface is a joystick or a revolving rheostat.
